(19) United States
(12) Patent Application Publication
(10) Pub. No.: US 2022/0268514 A1
(43) Pub. Date: Aug. 25, 2022

(54) Modular Thermal Beverage Container

(71) Applicant: John C. Botdorf, Castle Rock, CO (US)

(72) Inventor: John C. Botdorf, Castle Rock, CO (US)

(21) Appl. No.: 17/692,689

(22) Filed: Mar. 11, 2022

Related U.S. Application Data
(60) Provisional application No. 63/160,327, filed on Mar. 12, 2021.
(60) Provisional application No. 62/989,060, filed on Mar. 13, 2020.

(51) Int. Cl. F25D 31/00; A47J 41/00; B65D 23/10; B65D 51/24; F25D 3/06

(52) U.S. Cl. CPC F25D 31/003; A47J 41/0044; A47J 41/0088; B65D 23/10; B65D 51/242; F25D 3/06; F25D 2303/0832

(57) ABSTRACT

The invention relates to a beverage container, and in particular a thermal beverage container having a modular thermal chilling mechanism that can be used to maintain the temperature of a beverage without the continual use of ice.

### CROSS REFERENCE TO RELATED APPLICATIONS

This application claims the benefit of and priority to U.S. Provisional Application No. 62/989,060, filed Mar. 13, 2020 and U.S. Provisional Application No. 63/160,327, filed Mar. 12, 2021. The entire specification and figures of the above-referenced applications are hereby incorporated in their entirety by reference.

### TECHNICAL FIELD

The invention relates to a beverage container, and in particular a thermal beverage container having a modular thermal chilling mechanism that can be used to maintain the temperature of a beverage without the continual use of ice.

### BACKGROUND

Beverage and other containers are well known in the art. Traditional beverage containers generally include a ruggedized outer body with a securable lid for holding a beverage or a beverage container. Some traditional beverage containers further include thermal insulation characteristics to maintain the beverage at a certain temperature. However, such traditional beverage containers are generally limited in functionality. For example, traditional beverage containers generally rely on thermal insulation to try and maintain the temperature of a beverage. However, this is limited by the fact that the beverage, or beverage container such as a bottle or can, must first be chilled prior to being placed into the container. This is typically accomplished through traditional refrigeration, or by placing ice directly into the beverage. Despite this, over time the limited ability of such basic thermal insulation will effectively prevent the beverage or beverage container from returning to the surrounding ambient temperature. In certain environments, such in hot climates or during summer months, this temperature equilibration may occur rapidly. The only solution to reduce the temperature, or chill the beverage is to place the beverage or container back into a traditional refrigerator or to add more ice. The latter option may be especially undesirable as the melted ice will dilute the beverage, and in some cases may be incompatible with certain beverage types, such as wine and other spirits.

As such, there exists a need for an improved beverage container that may provide improved thermal characteristics to maintain the temperature of a beverage, that in particular does not include the physical addition of ice to a beverage. Additionally, there exists a need for an improved beverage container that may provide improved thermal characteristics to maintain the temperature of a beverage container that is not amenable to the addition of ice, such as wine and other spirits.

### SUMMARY OF THE INVENTION

In one aspect the invention relates to an improved thermal beverage container configured to have a modular thermal chiller that can be used to chill or maintain the temperature of a beverage or beverage container.

In another aspect the invention, an improved thermal beverage container may include a modular base configured to have a thermal drawer. A thermal attachment having one or more chilled inserts may be inserted into and secured in the thermal drawer. The chilled insert(s) may be positioned in the thermal drawer in proximity to a thermally conductive interface such the that chilled inserts may chill or maintain the temperature of a beverage positioned in a beverage vessel that is thermally connected to the thermal drawer.

In another aspect the invention, an improved thermal beverage container may include a modular base configured to have one or more chilled inserts that may be in the thermal modular base. The modular base having one or more chilled insert(s) may include a thermally conductive interface such the that chilled inserts may chill or maintain the temperature of a beverage positioned in a beverage vessel that is thermally connected to the thermal modular base.

In another aspect the invention, an improved thermal beverage container may include a thermal slot configured to be positioned around a beverage vessel, and preferably in the body of a beverage container. A thermal attachment having one or more chilled inserts may be positioned in the thermal slot in proximity to a thermally conductive interface such that the chilled inserts may chill or maintain the temperature of a beverage positioned in a beverage vessel that is thermally connected to the thermal drawer.

Additional aspects of the invention may include one or more of the following preferred embodiments:
1. A modular thermal beverage container comprising:
   a container body having a beverage vessel configured to secure a beverage or a beverage container;
   a modular base configured to be coupled with said container body;
   at least one thermal drawer positioned within said modular base configured to receive at least one thermal attachment; and
   one or more chilled inserts positioned within said at least one thermal attachment and further configured to be in thermal communication with said beverage or a beverage container.
2. The container of embodiment 1, wherein said container body comprises a ruggedized container body selected from the group consisting of: a plastic ruggedized container body; a metal ruggedized container body; a thermoplastic ruggedized container body; an insulated ruggedized container body.
3. The container of embodiment 1, further comprising a lid coupler configured to be mated with and secure a lid.
4. The container of embodiment 1, further comprising a receptacle coupler configured to be mated with and secure said modular base.
5. The container of embodiment 1, further comprising a thermally conductive interface configured to be positioned proximate to said one or more chilled inserts and allow thermal communication from said chilled inserts to said beverage vessel.
6. The container of embodiment 5, wherein said thermally conductive interface is positioned on the bottom surface of the container body.
7. The container of embodiment 1, wherein said thermally conductive interface is positioned on the sidewalls of the container body.
8. The container of embodiment 1, wherein said thermally conductive interface is positioned on the top surface of the modular base.
9. The container of embodiment 1, wherein said one or more chilled inserts comprise one or more metal chilled inserts.
10. The container of embodiment 1, further comprising a thermal slot configured to secure one or more additional chilled inserts.
11. The container of embodiments 8 and 10, wherein said thermal slot comprises a thermal slow positioned internally along the sidewall of said container body in-between the outer shell of a container body and the inner shell.
12. The container of embodiment 1, further comprising one or more side handles coupled with said container body of a container body.
13. The container of embodiment 1, further comprising one or more adjustable handles coupled with said container body by an adjustable handle bracket.
14. The container of embodiment 1, further comprising a lid handle.
15. The container of embodiment 1, further comprising a strap bracket
16. The container of embodiment 1, wherein said one or more chilled inserts comprise ice.
17. The container of embodiment 1, wherein said one or more chilled inserts comprise dry ice.
18. The container of embodiment 1, further comprising a drain.
19. The container of embodiment 1, further comprising a drain plug, or a drain valve.
20. A modular thermal beverage container comprising:
   a container body having a beverage vessel configured to secure a beverage or a beverage container;
   a modular base configured to be coupled with said container body;
   a thermal drawer positioned within said modular base configured to receive a thermal attachment; and
   wherein said thermal attachment may be chilled prior to being positioned within said thermal drawer and further configured to be in thermal communication with said beverage or a beverage container.
21. A modular thermal beverage container comprising:
   a container body having a beverage vessel configured to secure a beverage or a beverage container;
   a modular base configured to be coupled with said container body wherein said modular base may be chilled prior to being coupled with said container body and further configured to be in thermal communication with said beverage or a beverage container.

Additional aspects of the invention may become evident through the specification, figures and claims provided below.

### BRIEF DESCRIPTION OF THE FIGURES

The novel aspects, features, and advantages of the present disclosure will be better understood from the following detailed descriptions taken in conjunction with the accompanying figures, all of which are given by way of illustration only, and are not limiting the presently disclosed embodiments, in which:

FIG. 1 shows a modular thermal beverage container having a thermal drawer with a plurality of chilled inserts in one embodiment thereof;

FIG. 2 shows an exploded view of a thermal beverage container in one embodiment thereof;

FIG. 3 shows an isolated body of a modular thermal beverage container in one embodiment thereof;

FIG. 4 shows an isolated modular base with a thermally conductive interface in one embodiment thereof;

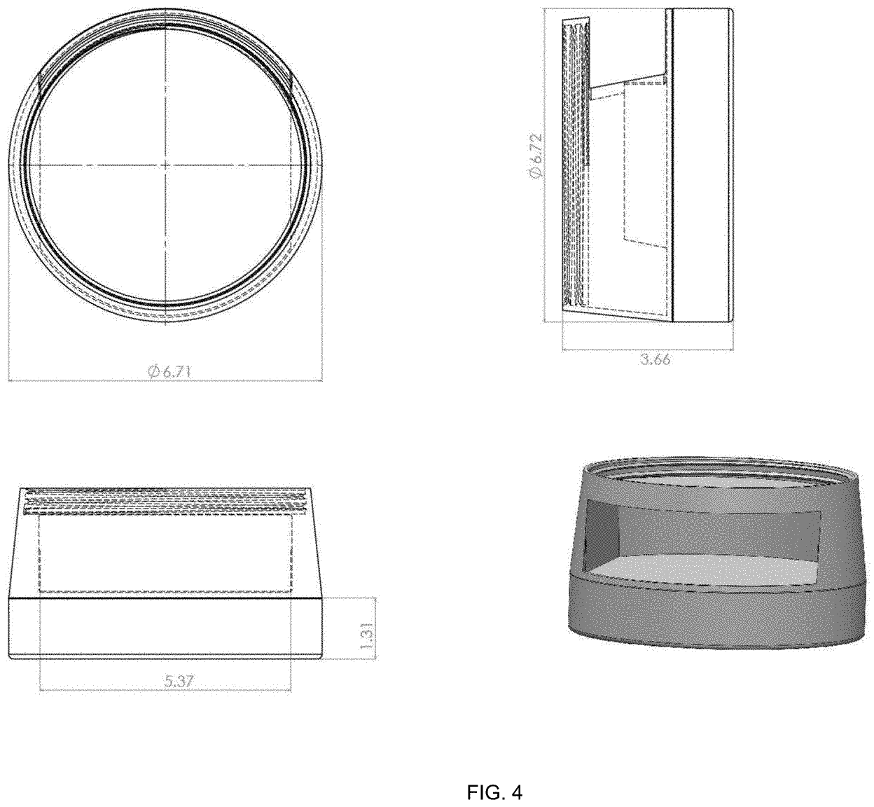

FIG. 5 shows an isolated handle component in one embodiment thereof;

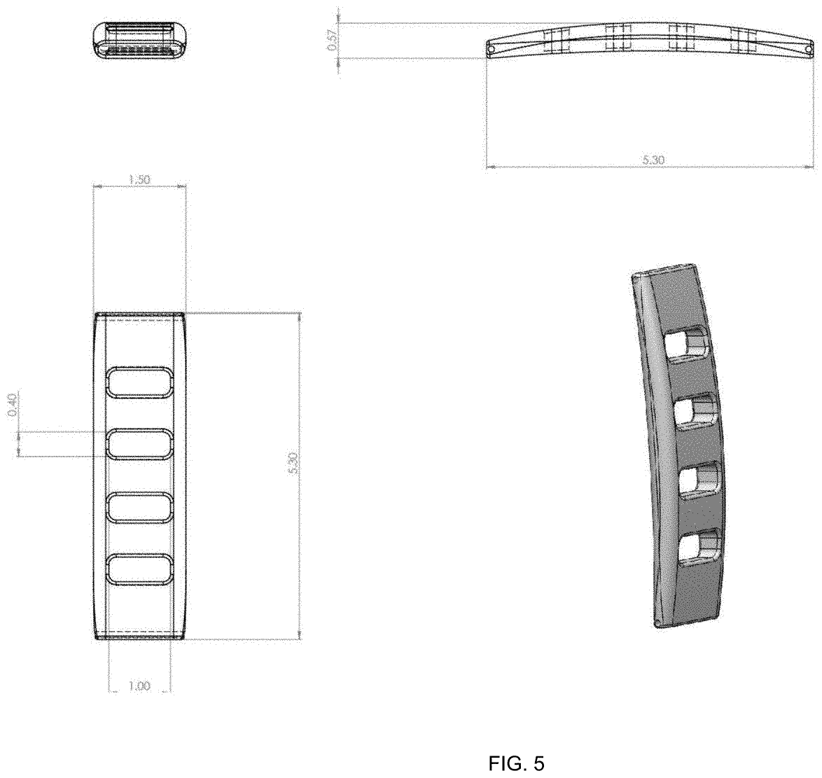

FIG. 6 shows an isolated thermal drawer in one embodiment thereof;

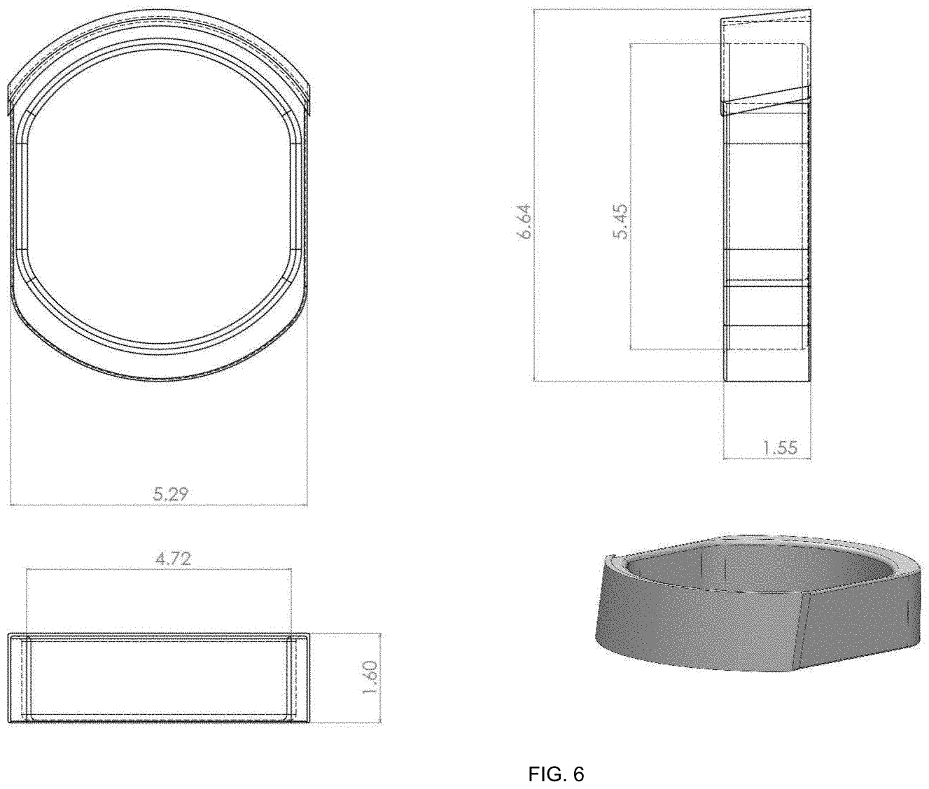

FIG. 7 shows an isolated chilled insert in one embodiment thereof; and

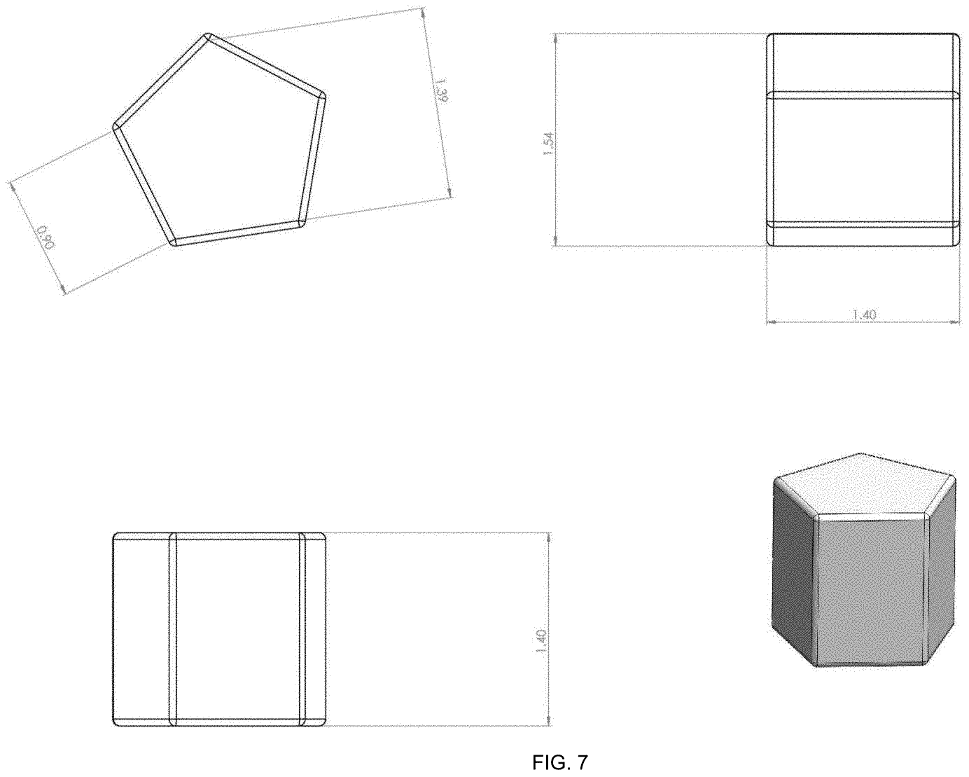

FIG. 8 shows an isolated lid handle in one embodiment thereof; and

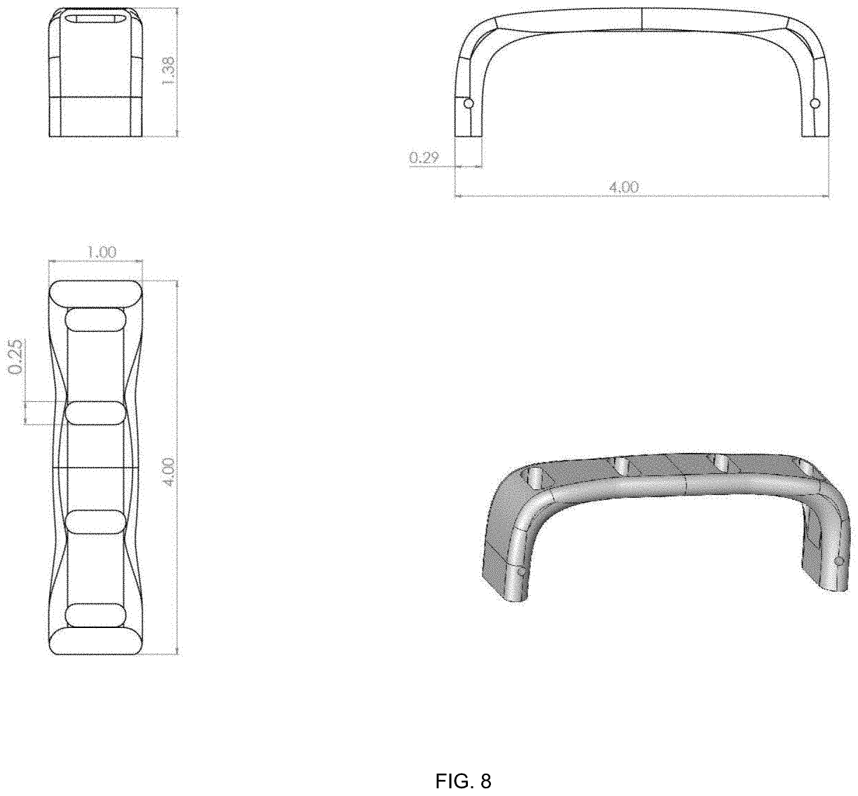

FIG. 9 shows an isolated strap bracket.

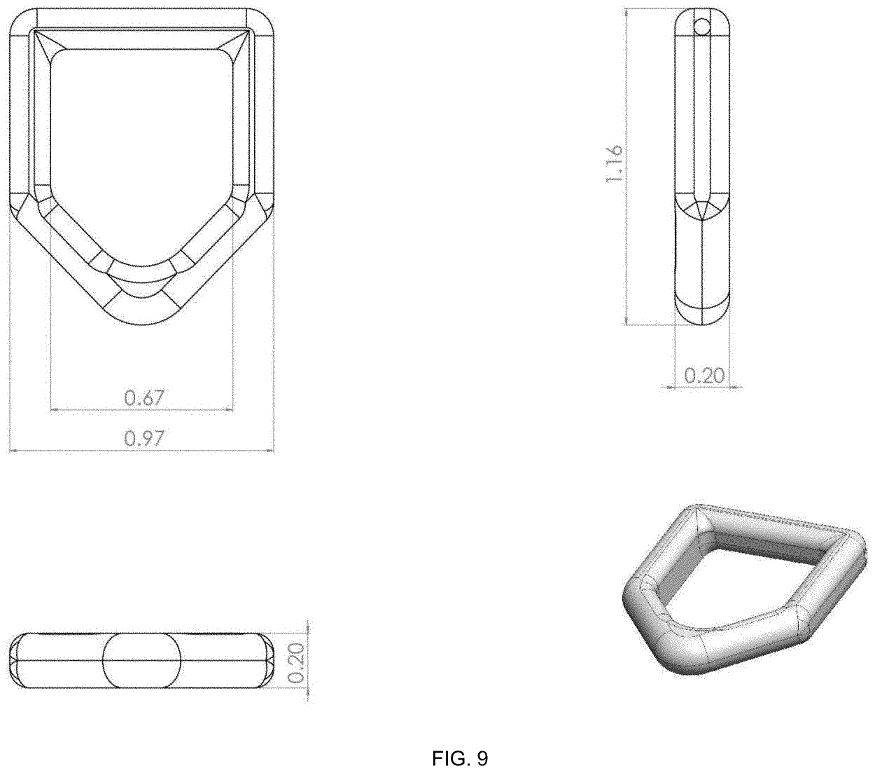

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

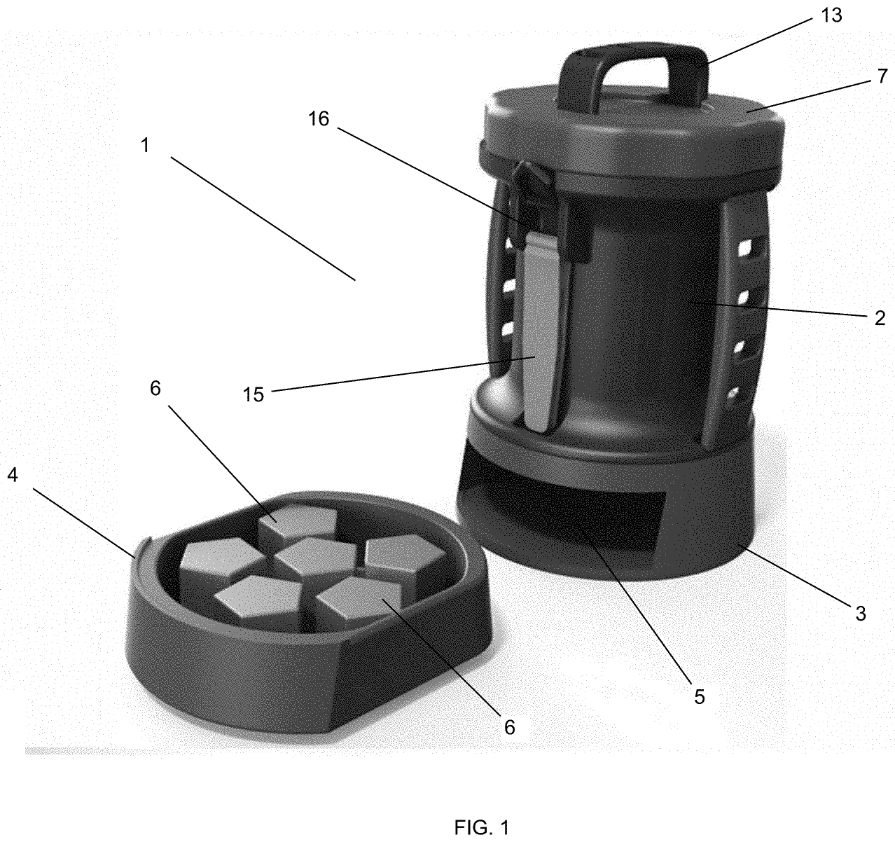

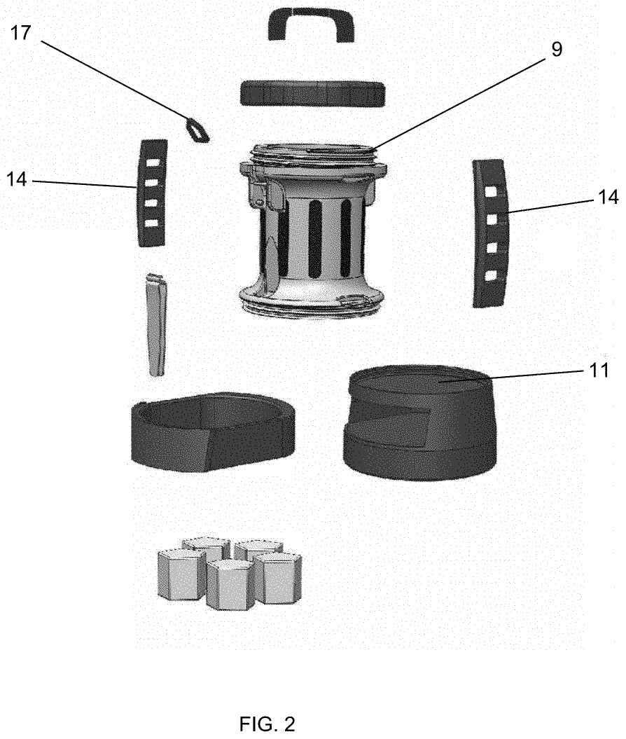

The inventive technology may include a modular thermal beverage container (1). Generally referring to FIGS. 1-2, in one preferred embodiment a modular thermal beverage container (1) may include a container body (2) which may further be formed from a ruggedized material, such as hard plastic, metal, or other like compositions. The container body (2) may include an internally situated beverage vessel (8) that may further be configured to directly hold a liquid beverage, or a beverage container such as a can, or glass bottle and the like. In the preferred embodiment shown in the figures, the container body (2) may be formed as a unitary component, for example through injection molding or other similar manufacturing processes known in the art.

The container body of the invention may further be configured to be secured with a lid (7) component that may further include a handle (13) that may allow a user to easily lift and carry the modular container of the invention. Additional embodiments may include a variety of different mechanisms and configurations to secure a lid (7) component to the container body (2). For example, in certain embodiments the lid (7) component may be secured to the container body (2). through one or more lid couplers (9), such as a threaded coupler shown in FIG. 2, as well as in alternative embodiments a quick release coupler, a slide coupler, a snap coupler and the like. In certain embodiment, a lid handle (13) may allow a user to secure and unsecure a lid (7) component, for example where it is secured to the container body (2) by a threaded or sliding coupler mechanism as generally shown in FIG. 2. Additionally, in certain embodiments the lid (7) component may be secured to the container body (2) through one or more locks that may be configured to secure the lid (7) component to the container body (2) securing the beverage vessel (8), and preferably securing the beverage vessel (8) of the container in a liquid tight fashion.

In certain embodiments, the container body (2) may include a plurality of anchor positions to secure attachments, such as a strap bracket (17), or a plurality of handles (14). As generally shown in FIG. 1, in one preferred embodiment one or more handles (14) may be positioned in a set off configuration such that a user may grasp the handle to lift the modular container, while also allowing a user to grasp the container body (2) and use the handles (14) as a bracing support device that may be secured against a top portion of a user's hand when lifting the container. As shown in FIGS. 1-2, a container body (2) may include one or more adjustable handles (15). In this embodiment, a container body (2) may be configured with an adjustable handle bracket (16) that may be mated with an adjustable handle (15). As shown in FIG. 1 generally, in one embodiment an adjustable handle (15) may be extended outward to a pre-determined angle to form a handle that can be grasped by a user to move or adjust the container of the invention. In this embodiment, the adjustable handle (15) may be coupled to an adjustable handle bracket (16) by a slotted bracket coupling with a mechanical stop positioned to prevent the adjustable handle (15) from extending beyond a predetermined angle away from the container body. In alternative embodiment, the adjustable handle bracket (16) of the invention may include one or more locking positions that may allow the adjustable handle (15) to extend only to a pre-determined angle away from the container body. In this embodiment, the pre-determined angle may be determined by positioning the adjustable handle (15) such that, for example a slot extension is mated with a slot position along a range of slot positions corresponding to a plurality of angled positions to which the handle may be secured.

In another preferred embodiment, the modular thermal beverage container (1) of the invention may include one or more systems and methods to chill a beverage or beverage container, such as a wine bottle, positioned in the beverage vessel (8) or the container body (2). In one preferred embodiment a modular thermal beverage container (1) may include or be configured to be coupled with a modular base (3) having one or more thermal drawers (5). Generally referring to FIGS. 1 and 2, in this embodiment a thermal drawer (5) may be configured to secure a thermal attachment (4) having one or more chilled inserts (6). In this configuration, one or more chilled inserts (6) may be pre-chilled in a freezer or other refrigeration device and positioned in the thermal attachment (4). As shown in FIG. 2, a thermal attachment (4) may be inserted into a modular base (3) and secured in position by one or more couplers devices or other mechanical fittings. When positioned within the modular base (3), the one or more chilled inserts (6) may be positioned proximate to a thermally conductive interface (11) that allows thermal conduction between the beverage vessel (8) and modular base (3). Notably, in one embodiment, a modular base (3) may include a fully-enclosed modular base (3) that may have one or more internally positioned shilled insert(s) (6). In this embodiment, the modular base (3) may be pre-chilled or frozen and coupled with the container base (2) such that the internally positioned shilled insert(s) (6) may be positioned next to a thermally conductive interface (11) that allows thermal conduction between the beverage vessel (8) and modular base (3). In another embodiment, as noted below, to maintain the chilled temperature of a beverage or beverage container positioned within the beverage vessel (8), a modular base (3) may be continually replaced with another pre-chilled base so as to maintain the chilled beverage or beverage container constant as desired by a user.

In one embodiment, this thermally conductive interface (11) may include a surface that lacks insulation allowing thermal communication across the interface's surface and thereby allowing the thermal chillers (6) to reduce the temperature of the beverage or beverage container positioned within a beverage vessel (8). In another embodiment, a thermally conductive interface (11) may include a thermally conductive material, such as a metal interface, that may further be positioned within the bottom and sides of the container body (2) such that the chilled inserts (6) may reduce the temperature of the thermally conductive interface that surrounds the beverage vessel thereby chilling the beverage or beverage container positioned within a beverage vessel (8). In still further embodiments, a thermally conductive interface (11) may further include an air-filled void that may be thermally responsive to the action of the chilled insert (6). In this embodiment, the chilled inserts may reduce the temperature of the air within the thermally conductive interface (11) allowing the thermal chillers (6) to reduce the temperature of the beverage or beverage container positioned within a beverage vessel (8). In still further embodiments, may further include a void surrounding the beverage vessel (8) filled with a freezable material, such as a liquid or gel having a lower freezing temperature than that of water, that may be thermally responsive to the action of the chilled insert (6). In this embodiment, the chilled inserts may reduce the temperature of the liquid or gel within the thermally conductive interface (11) allowing the thermal chillers (6) to reduce the temperature of the beverage or beverage container positioned within a beverage vessel (8).

It should be noted that in the preferred embodiment shown in the figures these chilled inserts (6) may include a plurality of metal blocks that may be frozen prior to being placed in the thermal attachment (4). In this configuration, the chilled inserts (6) may be positioned in the thermal attachment (4) and further inserted into the modular base (3), while in other embodiments, the chilled inserts (6) may be directly positioned within the modular base (3), and secured, for example, through a sliding or lockable door component. In still further embodiments, a thermal attachment (4) may serve as a chilled insert, the two items being a unitary component. In this embodiment, a chilled insert (6) may be configured with an outer protective surface and further configured to be positioned within the modular base (3) so as to be positioned in close proximity to the thermally conductive interface (11) described above, while the protective surface may be secured to the outer surface or portion of the modular base (3) to provide insulation and protection against undesired thermal loss or heat exchange.

As noted above, in one embodiment shown in the figures a chilled insert (6) may include a plurality of metal blocks that may be pre-chilled prior to use with the modular container of the invention. Such metal blocks may be formed from a solid metal block, such as stainless-steel, while in alternative embodiment metal blocks may include a liquid or gel interior core surrounded by a metal, and preferably a stainless-steel enclosure. In this embodiment, the encapsulated liquid or gel may be frozen and may be providing an improved chilling action on a beverage or beverage container positioned within the beverage vessel (8) as described below. Notably, in and additional embodiment frozen water ice-cubes may be used as a chilled insert (6), as well as any sufficiently frozen or cold compound that may reduce the temperature of a beverage or beverage container in the beverage vessel (8). Notably, when using un-encapsulated ice, one or more drains may be incorporated into the modular base (3) or the container body (2).

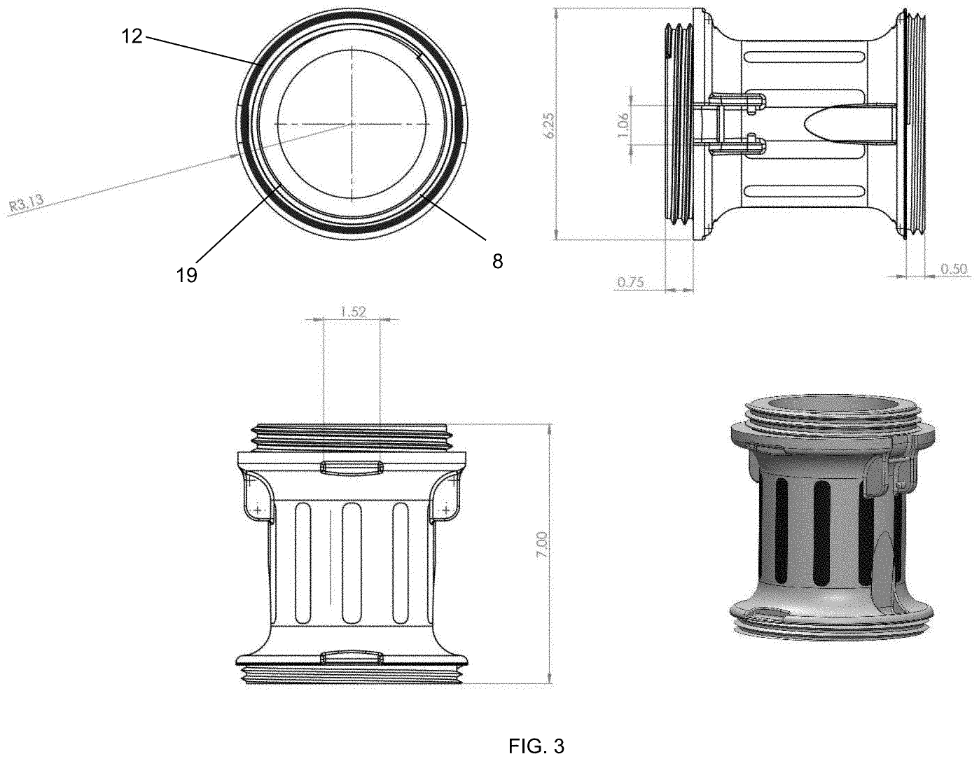

In another embodiment, a container body (2) may further include one or more thermal slots (12). Generally referring to FIG. 3, a thermal slot (12) may include an internal void positioned within the beverage vessel that may further be configured to hold one or more chilled inserts (6).

Again, referring to FIG. 3, in this embodiment the outer shell of a container body (18) may be separated from the inner shell of a container body (19) by a thermal slot (12), wherein the thermal slot (12) may be configured to hold one or more chilled inserts (6), such insert being in this embodiment elongated metal packs that may be pre-chilled and inserted into the thermal slot (12) and so be positioned proximate to a thermally conductive interface (11) positioned between the beverage vessel (8) and the inner shell of a container body (19). In another preferred embodiment, a chilled insert (6) configured to be positioned in a thermal slot (12) may include a circular chilled insert (6) that when secured in a thermal slot (12) may encompass the beverage vessel, and further be in thermal communication with a thermally conductive interface (11) positioned between the beverage vessel (8) and the inner shell of a container body (19). As noted above, in certain embodiments, a chilled insert (6) may include an unencapsulated frozen liquid, such as ice, dry ice, or a low-temperature liquid such as chilled water or a gel having a freezing temperature lower than water. In such an embodiment, thermal slot (12) positioned within a container body (2) may include one more venting holes for liquid or gas to escape. Such venting holes may further include a plug or valve for the controlled release of any liquid or gas. In an additional embodiment, a container body (2) may include a reservoir to collect melted liquid, for example that may continue to chill the beverage or beverage container, but also be released through a valve- or plug-regulated venting hole.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves apparatus, systems, methods, and techniques as well as devices to accomplish a thermal beverage container having, in a preferred embodiment a modular chilling system. In this application, the improved techniques, including novel and unique methods and apparatus for a modular thermal beverage container and the like are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements.

Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms -- even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupling method and/or technique, and or device.” Such changes and alternative terms are to be understood to be explicitly included in the description.

Thus, the applicant(s) should be understood to have support to claim and make a statement of invention to at least: i) each of the methods, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A modular thermal beverage container comprising:
a container body having a beverage vessel configured to secure a beverage or a beverage container;
a modular base configured to be coupled with said container body;
at least one thermal drawer positioned within said modular base configured to receive at least one thermal attachment; and
one or more chilled inserts positioned within said at least one thermal attachment and further configured to be in thermal communication with said beverage or a beverage container.

2. The container of claim 1, wherein said container body comprises a ruggedized container body selected from the group consisting of: a plastic ruggedized container body; a metal ruggedized container body; a thermoplastic ruggedized container body; an insulated ruggedized container body.

3. The container of claim 1, further comprising a lid coupler configured to be mated with and secure a lid.

4. The container of claim 1, further comprising a receptacle coupler configured to be mated with and secure said modular base.

5. The container of claim 1, further comprising a thermally conductive interface configured to be positioned proximate to said one or more chilled inserts and allow thermal communication from said chilled inserts to said beverage vessel.

6. The container of claim 5, wherein said thermally conductive interface is positioned on the bottom surface of the container body.

7. The container of claim 1, wherein said thermally conductive interface is positioned on the sidewalls of the container body.

8. The container of claim 1, wherein said thermally conductive interface is positioned on the top surface of the modular base.

9. The container of claim 1, wherein said one or more chilled inserts comprise one or more metal chilled inserts.

10. The container of claim 1, further comprising a thermal slot configured to secure one or more additional chilled inserts.

11. The container of claims 8 and 10, wherein said thermal slot comprises a thermal slow positioned internally along the sidewall of said container body in-between the outer shell of a container body and the inner shell.

12. The container of claim 1, further comprising one or more side handles coupled with said container body of a container body.

13. The container of claim 1, further comprising one or more adjustable handles coupled with said container body by an adjustable handle bracket.

14. The container of claim 1, further comprising a lid handle.

15. The container of claim 1, further comprising a strap bracket

16. The container of claim 1, wherein said one or more chilled inserts comprise ice.

17. The container of claim 1, wherein said one or more chilled inserts comprise dry ice.

18. The container of claim 1, further comprising container body having a drain.

19. The container of claim 1, further comprising a drain plug, or a drain valve.

20. A modular thermal beverage container comprising:
a container body having a beverage vessel configured to secure a beverage or a beverage container;
a modular base configured to be coupled with said container body;
a thermal drawer positioned within said modular base configured to receive a thermal attachment; and
wherein said thermal attachment may be chilled prior to being positioned within said thermal drawer and further configured to be in thermal communication with said beverage or a beverage container.

21. A modular thermal beverage container comprising:
a container body having a beverage vessel configured to secure a beverage or a beverage container;
a modular base configured to be coupled with said container body wherein said modular base may be chilled prior to being coupled with said container body and further configured to be in thermal communication with said beverage or a beverage container.
